(19) United States
(12) Patent Application Publication
(10) Pub. No.: US 2009/0150844 A1
(43) Pub. Date: Jun. 11, 2009

(54) CRITICAL PATH SELECTION FOR AT-SPEED TEST

(75) Inventors: Vikram Iyengar, South Burlington, VT (US); David E. Lackey, Jericho, VT (US); Subbayyan Venkatesan, San Jose, CA (US); Chandramouli Visweswariah, Croton-on-Hudson, NY (US); Jinjun Xiong, White Plains, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 11/954,138

(22) Filed: Dec. 11, 2007

(51) Int. Cl. G06F 17/50

(52) U.S. Cl. 716/6

(57) ABSTRACT

A method of critical path selection provides a set of paths that initially contains no paths. A timing tool is used to identify potential critical paths of an integrated circuit design. Each potential critical path is evaluated and the potential critical path is added to the set of paths if logic devices within the potential critical path are shared by less than a predetermined number of critical paths within the set of paths. This evaluating and adding process is repeated for each of the potential critical paths until all of the potential critical paths have been evaluated. Then, the potential critical paths within the set of paths can be output.

### BACKGROUND

### Field of the Invention

The invention relates to identifying critical paths within integrated circuits, and more particularly to a method that reduces the number of repetitive false paths by limiting the number of critical paths that can include a given gate, memory element, logic block, or net.

### SUMMARY

At-speed test of critical paths within integrated circuits is important for performance verification as well as to provide feedback from manufacturing to reduce timing pessimism and account for process variation. However, identifying true critical paths that are critical over a large portion of the process space is not trivial.

In view of the foregoing, embodiments of the invention provide a method of critical path selection. The method performs statistical timing to compute node criticalities for an integrated circuit design and identifies nodes having the highest criticalities as critical nodes. Statistical path tracing through the critical nodes is performed to identify potential critical paths and repetitive false ones of the potential critical paths are filtered out.

More specifically, the filtering process provides a set of paths that initially contains no paths. Each potential critical path is evaluated and the potential critical path is added to the set of paths only if logic devices within the potential critical path are shared by less than a predetermined number of critical paths within the set of paths. This evaluating and adding process is repeated for each of the potential critical paths until all of the potential critical paths have been evaluated. Then, the potential critical paths within the set of paths can be output as the critical paths for at-speed test.

Different embodiments can alter the “evaluation” and “adding” processes mentioned above, to determine whether the potential critical path and the critical paths within the set of paths share: launch memory element and critical node pairs; capture memory element and critical node pairs; or launch memory element, capture memory element, and critical node 3-tuples. Similarly, other embodiments can alter the evaluation and adding processes to determine whether the critical node that the potential critical path passes through is the endpoint of the potential critical path.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment of the invention; and

FIG. 2 is a schematic diagram illustrating a representative integrated circuit structure, for which critical paths may be selected for at-speed test, using a method embodiment of the invention illustrated in FIG. 1.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, identifying true critical paths that are critical over a large portion of the process space is not trivial. Many of the least-slack paths produced by deterministic timing are false, and cannot or should not be exercised by at-speed test. For example, repetitive low-slack Boolean false paths may be picked up by the timing tool, since it does not perform logic simulation. In view of this, the present disclosure presents a method to identify critical paths for at-speed test.

Various known solutions include identifying least-slack paths from deterministic timing. However, many of the paths identified by such a method are false. Moreover, these paths may not be critical across the process space. Treating the size of node delays as a random variable and using Monte Carlo simulation or integer linear programming to uncover critical paths is computationally impossible for large circuits; and the paths identified may be false. When using partial path tracing with logic implication to identify true paths, process and environmental parameters are not considered.

Therefore, the present embodiments provide a method that performs statistical timing and computes node criticalities for the design. The method identifies the critical nodes having the highest criticalities. Next, statistical path tracing through the critical nodes is performed. When using node criticalities as a starting point to identify critical paths passing through the nodes, many critical nodes on the same Boolean false path may be identified and repetitive false paths may be traced through the same reconvergent logic segment. Therefore, in the next step, several methods to filter out false and repetitive paths are performed. The method provides several simple filtering mechanisms to ensure that the multiple paths identified do not pass through the same logic segment more than a predetermined number of times, even if many critical nodes are identified on the same logic segment. This prevents the case of the same reconvergent logic segment from being present in many of the critical paths identified.

If paths passing through a reconvergent logic segment are long and low-slack, then the timing tool may deem many of the nodes on the segment as being critical. Hence, many paths passing through the same reconvergent logic segment may be picked up for testing; however, many of the paths will not produce any patterns. To avoid this repetitive false path problem, the embodiments herein identify critical paths across the process space as presented in the following pseudo code:

1 Let set of paths P be empty;
2 Identify a set of ASST-testable clock domains;
Identify critical paths
3 For each ASST-testable clock domain
4 Perform statistical timing in ASST mode;
5 Compute criticality probabilities for all nodes;
6 Select a set of nodes ranked most critical;
7 For each critical node Ni
8 Find all capture memory elements fed by this node;
9 For each capture memory element Fj
10 Identify a number of least-slack memory element-to-
memory element paths that pass through Ni and end at Fj;
Avoid false paths
11 For each path p identified in Line 10
12 If path passes the new filtering rules

13 Add path p to set P;

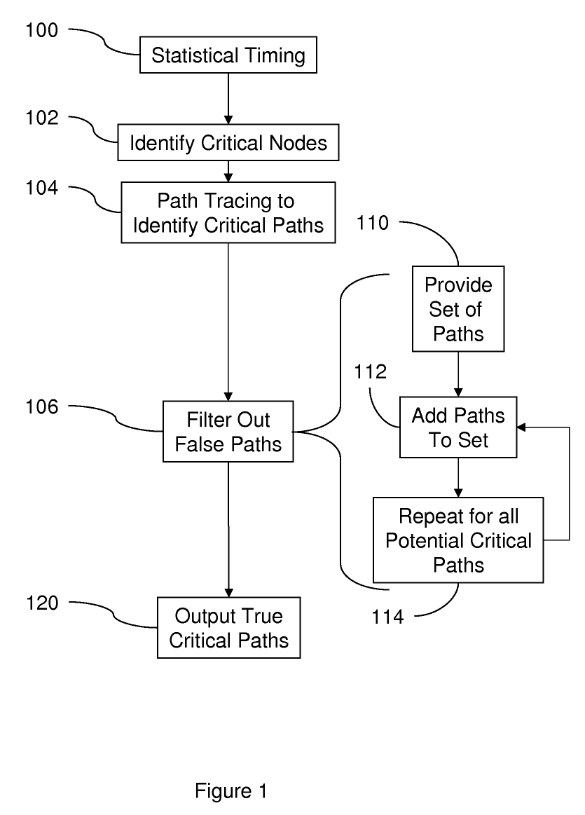

The same processing is shown in flowchart form in FIG. 1. Thus, FIG. 1 illustrates embodiments of the invention that provide a method of critical path selection. In item 100, the method performs statistical timing to compute node criticalities for an integrated circuit design and, in item 102, identifies nodes having the highest criticalities as critical nodes. Statistical path tracing through the critical nodes is performed in item 104 to identify potential critical paths and repetitive false ones of the potential critical paths are filtered out in item 106.

More specifically, the filtering process in item 106 provides an empty set of paths that initially contains no paths (item 110). Each potential critical path is evaluated and the potential critical path is added to the set of paths only if logic devices within the potential critical path are shared by less than a predetermined number of critical paths within the set of paths in item 112. Examples of logic devices are gates, nets, logic blocks, or memory elements. However, it will be appreciated that other types of logic devices may be substituted in the following description, without departing from the scope of the invention. This evaluating and adding process is repeated for each of the potential critical paths until all of the potential critical paths have been evaluated as shown by item 114. Then the potential critical paths within the set of paths can be output as the critical paths in item 120.

Different embodiments can alter the evaluation and adding process to determine whether the potential critical path and the critical paths within the set of paths share: launch memory element and critical node pairs; capture memory element and critical node pairs; or launch memory element, capture memory element, and critical node 3-tuples. Similarly, other embodiments can alter the evaluation and adding process to determine whether the critical node that the potential critical path passes through is the endpoint of the potential critical path.

Thus, the filtering rules referred to above in Line 12 above are each an embodiment of the invention. In one embodiment, if any gate, net, memory element, or logic block in the new path identified in Line 10 has already appeared n times in set P, then the method does not add the new path to set P.

In another embodiment, as new paths are added to set P, the method maintains a list L of (launch memory element, critical node) pairs. If the launch memory element and critical node for the new path identified in Line 10 has already appeared n times in list L, then the method does not add the new path to set P. One possible implementation of this embodiment comprises the following processing. First (Step A), this method creates an associative array called “pinioList,” whose index is the critical node and contents are all of its end points fed by that critical node. Next (Step B), the method loops through every single end point (e.g. 30 end points) fed by the critical node (node A) and generates the critical paths, a maximum of n (e.g., 8) paths to the end points. Then (Step C), while generating the path per end point, the method analyzes every element from the path to see if any other critical node (node X) and the same end points exists in that “pinioList” array; if so this end point is removed from that array with the index “node X”. Thus, the scenario is “critical node A”→“critical node X”→end points (or “critical node X”→“critical node A”→end points). Array: pinioList (A) (end points); pinioList (X) (end points). Thus, the above filtering removes paths through node X to the already addressed end point. In the next step (Step D), the method creates another array called critL whose index is “critical node and launch memory element”; whose element (only one) is the counter. This is incremented every time the same critical node and the same launch memory element are repeated. Thus, assuming a launch memory element (say M), goes through the (node A) to end points, if the counter reaches n (say, 8), the paths get dropped.

In another similar embodiment, as new paths are added to set P, the method maintains a list L of (capture memory element, critical node) pairs. If the capture memory element and critical node for the new path identified in Line 10 has already appeared n times in list L, then the method does not add the new path to set P. In a further similar embodiment, as new paths are added to set P, the method maintains a list L of (launch memory element, capture memory element, critical node) 3-tuples. If the launch memory element, capture memory element and critical node for the new path identified in Line 10 has already appeared n times in list L, then the method does not add the new path to set P. In another embodiment, only critical nodes at endpoints are considered. Thus, in this embodiment, a maximum of n paths per endpoint are added to set P.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

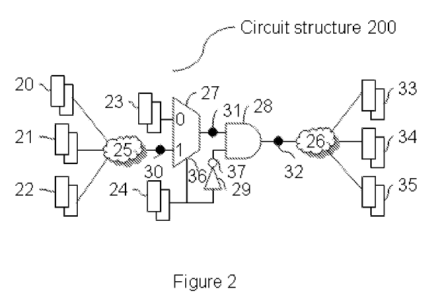

For the purposes of illustration, a representative logic circuit structure 200 is shown in FIG. 2. For purposes of simplicity, only three gate types (multiplexer 27, AND gate 28, and inverter 29) have been included. It will be appreciated that other types of gates, logic devices, memory elements, and circuit structures may be added to or substituted in the following description, without departing from the scope of the invention. The circuit structure 200 includes five launch memory elements 20, 21, 22, 23, and 24. The circuit structure 200 further includes two combinational logic structures 25 and 26. The circuit structure 200 also includes three gates (multiplexer 27, AND gate 28, and inverter 29). The select input pin of multiplexer 27 is labeled 36. The output pin of inverter 29 is labeled 37. Moreover, the circuit structure 200 includes three critical nodes 30, 31, and 32. Furthermore, the circuit structure 200 includes three capture memory elements 33, 34, and 35.

The partial logic path segment 30-27-31 in circuit structure 200 is Boolean false, as explained in the following description. To sensitize the partial logic path segment 30-27-31 in circuit structure 200, the Boolean-1 value must be placed on the select input pin 36 of multiplexer 27. However, placing the Boolean-1 value on the select input pin 36 of multiplexer 27 causes the Boolean-0 value on the output pin 37 of inverter 29. Hence, the output of the AND gate 28 is forced to the Boolean-0 value. As a result, the sensitization of the partial logic path segment 30-27-31 is blocked at AND gate 28. The partial logic path segment 30-27-31 is therefore Boolean false. Hence, every logic path, e.g., 20-30-27-31-33, in circuit structure 200 that passes through the partial logic path segment 30-27-31 is an impossible propagation false path and cannot be sensitized.

Referring back to FIG. 1, in item 100, the method performs statistical timing to compute node criticalities for the integrated circuit structure 200. In item 102, the method identifies nodes 30, 31, and 32 having the highest criticalities as critical nodes. Statistical path tracing through the critical nodes is performed in item 104 to identify potential critical paths passing through the critical nodes. Referring to FIG. 2, nine potential critical paths in circuit structure 200 can be traced through the critical node 30. The same nine potential critical paths are (20-30-27-31-33, 20-30-27-31-34, . . . , 22-30-27-31-35). Since the same nine potential critical paths all pass through the Boolean false partial logic path segment 30-27-31, all the same nine potential critical paths are Boolean false. Next, the same nine potential critical paths can be traced through the critical node 31. Further, the same nine potential critical paths can be traced through the critical node 32. Hence, twenty seven Boolean false potential critical paths would be traced through the three critical nodes 30, 31, and 32 in item 104 of FIG. 1.

These repetitive false paths of the potential critical paths are filtered out in item 106 of FIG. 1. More specifically, the filtering process in item 106 provides an empty set of paths that initially contains no paths (item 110). Each of the twenty seven potential critical paths is evaluated and the potential critical path is added to the set of paths only if logic devices, e.g., multiplexer 27, within the potential critical path are shared by less than a predetermined number of critical paths within the set of paths in item 112. This evaluating and adding process is repeated for each of the potential critical paths until all of the potential critical paths have been evaluated as shown by item 114. Then the potential critical paths within the set of paths can be output in item 120.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method of critical path selection comprising:
providing a set of paths, initially containing no paths;
identifying potential critical paths of an integrated circuit design using a timing tool;
evaluating each potential critical path and adding said potential critical path to said set of paths if logic devices within said potential critical path are shared by less than a predetermined number of critical paths within said set of paths;
repeating said evaluating and said adding for each of said potential critical paths until all of said potential critical paths identified by said timing tool are evaluated; and
outputting potential critical paths within said set of paths.

2. The method according to claim 1, all the limitations of which are incorporated herein by reference, wherein said evaluating determines whether said potential critical path and said critical paths within said set of paths share at least one of:
launch memory element and critical node pairs;
capture memory element and critical node pairs; and
launch memory element, capture memory element, and critical node 3-tuples.

3. The method according to claim 1, all the limitations of which are incorporated herein by reference, wherein said evaluating determines whether said potential critical path and said critical paths within said set of paths share only critical endpoint nodes.

4. A method of critical path selection comprising:
performing statistical timing to compute node criticalities for an integrated circuit design;
identifying nodes having the highest criticalities as critical nodes;
performing statistical path tracing through said critical nodes to identify potential critical paths; and
filtering out repetitive false ones of said potential critical paths in a process comprising:
providing a set of paths, initially containing no paths;
evaluating each potential critical path and adding said potential critical path to said set of paths if logic devices within said potential critical path are shared by less than a predetermined number of critical paths within said set of paths; and
repeating said evaluating and said adding for each of said potential critical paths until all of said potential critical paths are evaluated; and
outputting potential critical paths within said set of paths.

5. The method according to claim 4, all the limitations of which are incorporated herein by reference, wherein said evaluating determines whether said potential critical path and said critical paths within said set of paths share at least one of:
launch memory element and critical node pairs;
capture memory element and critical node pairs; and
launch memory element, capture memory element, and critical node 3-tuples.

6. The method according to claim 4, all the limitations of which are incorporated herein by reference, wherein said evaluating determines whether said potential critical path and said critical paths within said set of paths share only critical endpoint nodes.
